(19) United States
(12) Patent Application Publication
(10) Pub. No.: US 2026/0245532 A1
(43) Pub. Date: Aug. 20, 2026

(54) Variably Decoupled Electronic Hi-hat Controller

(71) Applicant: John Joseph Pelletier, Alton, NH (US)

(72) Inventor: John Joseph Pelletier, Alton, NH (US)

(21) Appl. No.: 19/054,902

(22) Filed: Feb. 16, 2025

(51) Int. Cl. G10D 13/10; G10D 13/065; G10D 13/11

(52) U.S. Cl. CPC G10D 13/26; G10D 13/065; G10D 13/11

(57) ABSTRACT

A hi-hat controller assembly for electronic hi-hats that enables sufficient freedom of motion of the top hi-hat cymbal and that of the the hi-hat rod to minimize mechanical interference between striking the top hi-hat cymbal and the player's intended foot position and motion. The assembly includes a mounting mechanism for attachment to a hi-hat rod, a coupling assembly for supporting a top hi-hat cymbal, and a resilient suspension element, such as a spring or elastomeric material. The resilient suspension element allows controlled movement of the foot position independent of direct mechanical coupling to the top cymbal, thereby optimizing the response characteristics of the electronic hi-hat system. The degree of decoupling can be adjusted to suit different playing preferences. The invention improves electronic hi-hat performance by providing a more natural feel and nuanced response.

### CROSS-REFERENCE TO RELATED APPLICATIONS

Provisional Application U.S. 63/554,504, filed Feb. 16, 2024 by John J. Pelletier

### BACKGROUND OF THE INVENTION

The present invention relates to electronic percussion instruments, and more particularly to an electronic hi-hat controller that enhances the feel and realism of hi-hat performance in electronic drum kits. This invention improves upon existing electronic hi-hat controllers by providing a more accurate response to foot position and stick dynamics, resulting in a playing experience that closely replicates that of an acoustic hi-hat. The invention finds applications in electronic drum sets for professional musicians, recording studios, and live performances, offering improved expressiveness, precision, and playability.

### SUMMARY OF THE INVENTION

The hi-hat is the most complex instrument with both electronic and acoustic drum sets. Electronic drummers strongly desire hi-hat controllers that emulate the feel, control and aesthetics of their acoustic counterparts, while providing the most accurate tracking of foot position possible. Like their acoustic counterparts, previous electronic hi-hat controller designs firmly couple the top cymbal to the clutch/pull rod/foot pedal linkage. However, as the top cymbal is struck, a firmly coupled linkage results in mechanical interference of foot position, resulting in unintended sensed foot position (meaning the resulting foot position sensed by the module or software). The VDEHC meets drummers'needs by taking a fundamentally different, novel and non-obvious approach by replacing the traditional clutch with a different mechanism, variably decoupling the top cymbal from the pull rod/foot pedal linkage. This permits the pedal sensing element to more accurately track foot position without mechanical interference. The object of this novel design is to maintain the interplay between foot and top cymbal position offered by stand-mounted hi-hats, while enabling precise measurement of foot position by the position sensor which itself is firmly coupled to the pull rod/foot pedal linkage. The result is more precise control of the desired “openness” sound for the performer without sacrificing the realism, feel and aesthetics of a stand-mounted electronic hi-hat.

### BRIEF DESCRIPTION OF DRAWINGS

FIG. 1. Variably Decoupled Hi-hat Clutch Assembly. This drawing shows the fully assembled variably decoupled clutch. Part 1 is a typical acoustic hi-hat clutch head with an attached 12 mm OD threaded hollow core. Part 2 is an optional spacer having an ID of 12 mm (sufficient to receive the hi-hat threaded core) and an OD of 25 mm to provide clearance between the clutch head wing nut and the pressure plate. Part 3 is a steel pressure plate measuring 1.5 mm thick with an OD of 53 mm and a 12 mm ID hole (sufficient to receive the hi-hat threaded core). Part 4 is a 10 mm thick microcellular polyurethane foam cushion with an OD of 35 mm and an ID hole of 16 mm (sufficient to receive the low friction sleeve). Part 5 is a 3 mm thick microcellular polyurethane foam cushion with an OD 32 of ID of 18 mm (sufficiently large so as not to cause friction as the low friction sleeve slides inside of it.) Part 6 is a 2 mm thick steel uplift plate with an ID of 17 mm (sufficiently large so as not to cause friction as the low friction sleeve slides inside of it) and an OD of 32 mm. Part 7 is a suspension spring with a wire diameter of 0.05″, an OD of 0.79″ and a length of 1″. Part 8 is a low friction sleeve consisting of cross-linked polyethylene tubing with an ID of 12 mm, an OD of 16 mm and a length of 33 mm. Part 9 is a standard 12 mm hi-hat nut with a recessed side wall to receive the suspension spring. Part 10 is a support plate to which is mounted either a reflective surface (in the case when the sensor is optical in nature, i.e., a TRTC5000) a rare earth magnet (in the case when the sensor is magnetic in nature, e.g., Hall effect) or a solid surface (in the case when the sensor is electromechanical, e.g., force sensing resistor). Part 11 is the pull rod which is part of a standard hi-hat stand, not shown. Part 12 is a typical electronic hi-hat cymbal with a center hole of 18 mm, sufficient for the low friction sleeve to move freely inside said hole, providing upward and downward motion when supported by the suspension spring as well as natural cymbal sway for a realistic playing experience.

FIG. 2. Variably Decoupled Hi-Hat Clutch Assembly, Exploded View. All of the corresponding parts which are shown in FIG. 1 also appear in this figure which in an exploded view of FIG. 1.

FIG. 3. Variably Decoupled Hi-Hat Clutch Assembly Showing Bottom Cymbal and Sensor. This figure shows the fully assembled clutch assembly as in FIG. 1. Part 12 a typical bottom cymbal made of either metal or rigid plastic. Part 13 is a rigid base to which the cymbal is rigidly attached. Part 13 is mounted rigidly to part 14, that being a standard 1″ OD hi-hat stand top tube. Part 15 is a controller sensor fixed element. (see “Detailed Description of the Invention.”) Part 16 is a physical calibration knob that enables the fixed sensor element to be positioned closer to, or further from the moveable sensor element.

### DETAILED DESCRIPTION OF THE INVENTION

The Variably Decoupled Electronic Hi-hat Clutch (VDEHC), introduces a novel approach to hi-hat clutch design by partially decoupling the attachment mechanism between the top hi-hat cymbal and the hi-hat stand's pull rod and associated linkages to the foot board and sensor mechanism. Traditional hi-hat clutches typically position the top cymbal between two felt pads (locked in place with flanking clutch nuts) with a fixed degree of motion between them. This intentionally limits the resulting freedom of movement between the top cymbal and the pull rod. The VDEHC is fundamentally different because, in contrast, it introduces substantial freedom of movement between the cymbal and pull rod. The VDEHC mechanically buffers the pull rod/foot pedal/sensor linkage from the top cymbal by virtue of the top cymbal being suspended by a spring (or other resilient material such as rubber, foam material, a gas-filled resilient material as in a balloon, etc., hereinafter generically used interchangeably with “spring”) within the clutch assembly, while the position sensor's moveable element remains fixed (coupled) to that linkage.

Further, in regard to variability, the VDEHC incorporates two design elements that work collaboratively so that the pedal is more decoupled while in an upward position (enhancing the articulation of slightly open to more open playing techniques) and is more fully coupled while in the downward position (enhancing closed and tightly closed playing techniques). Those two design elements are: suspension and cushioning. As the foot pedal is lifted, the support beneath the spring puts the spring under compression, which in turn applies upward lift on the cymbal. While moving upward, and/or in an upward position, the top cymbal behaves much like that of a traditional pair of hi-hats, with natural sway and movement, providing natural feel and aesthetics. As downward movement is applied to the pull rod by the pedal, the spring becomes relaxed, and the top cymbal moves naturally downward. Once the top and bottom cymbals come into contact with one another, this engages compression of the resilient material (microcellular polyurethane foam in the current design) beneath the so-called “pressure plate” positioned atop the cymbal, allowing the rod to continue to move downward under increasing pressure applied by the drummer's foot, said motion being detected continuously by the motion sensor. This compression enhances feel while allowing the sensor to detect what is known as the “tightly closed” position, correlating with the associated higher-pitched sound provided by the module or VST. A unique and distinct advantage of this stand-mounted system is that the foot position sensor element (reflector plate, magnet, or mechanical contactor), being firmly attached to the pull rod, moves independently from the top cymbal (with the benefits of a remote foot controller) with great precision and accuracy, as it is permanently affixed to the pull rod, unaffected by energy applied by striking the cymbal itself with a drum stick or other performance tool.

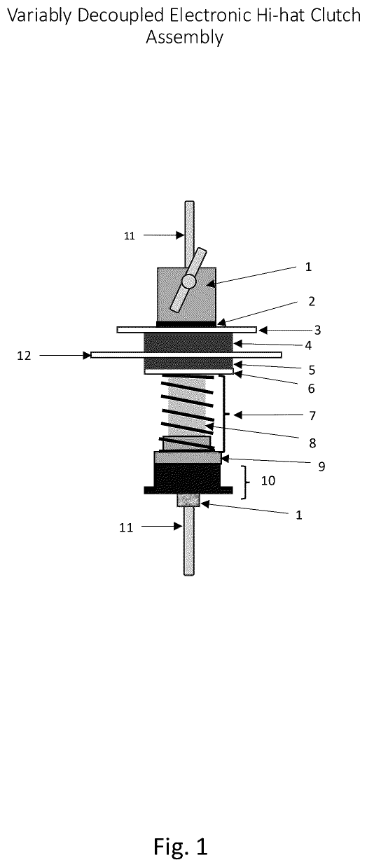

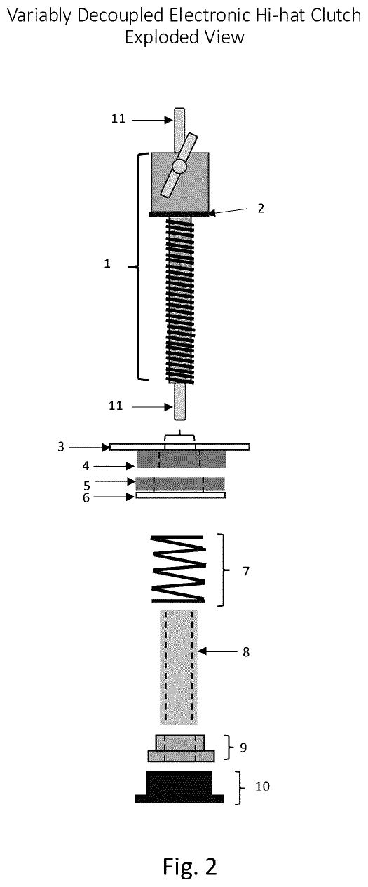

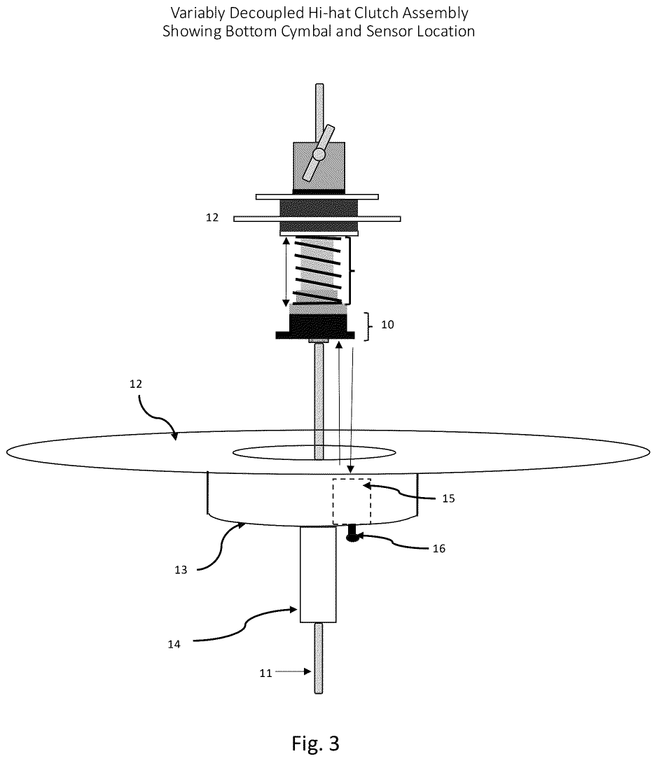

In the working prototypes depicted in FIG. 3, the position sensor systems employed have been either a) a TCRT5000optical sensor, b) a Hall Effect sensor or c) a force resistance resister (FSR) which is activated by a pinch roller which is attached to a mechanical piston. Other sensor types, may be used. With each of these systems, there is a fixed sensor element (firmly attached to the hi-hat stand) and a moveable element (firmly attached to the pull rod/foot board mechanism.) Foot board position is thus detected by measuring the distance between the fixed element and the moveable elements of the sensor system. In all three working prototypes, the moveable element of the sensor system is attached to the bottom of the hi-hat clutch depicted as part #10 in FIGS. 1-3 . In the case of the optical sensor, a reflector plate with a correct surface reflective index, selected to result in the optimal range of motion, was attached to the bottom of the clutch. In the case of a Hall effect sensor, a magnet with proper diameter and pull strength, also selected for optimal range of motion, was attached to the bottom of the clutch. In the case of the FSR sensor, the support plate makes direct contact with the mechanical piston actuator which is attached to the hi-hat stand. In all cases those moveable elements are round and remain perpendicular to the direction of motion of the pull rod, such that any rotation in the clutch during setup or play will not affect the calibrated range of motion. In each case the motion sensor's electronic components were attached inside the enclosure/base, shown in FIG. 3, though they can be attached to the hi-hat stand at any other location provided the distance from the moveable element can be measured. In each case the point of attachment of the fixed sensor element in the base was configured to be adjustable, enabling the user to bring the fixed sensor element closer to, or further from the moveable element. The adjustable point of attachment of the fixed element makes possible the implementation of a physical calibration/adjustment knob (part #16 in FIG. 3) which was incorporated into the VDEHC working prototype. This adjustment knob enables a change in the elevation of the sensor's fixed electronic element within the base, bringing it either more distal, or proximal, to the moveable sensor element which is itself attached to the clutch. This facilitates drummer's ability to quickly mechanically calibrate the position of baseline closed hi-hat position. This calibration feature has not been previously offered with other electronic hi-hat systems.

The VDEHC design is not obvious. Various attempts have previously been made by others to reduce interference caused by striking the top cymbal on foot position. Those approaches have focused on software algorithms to mask this phenomenon. That comes at a performance cost because any algorithm that affects motion detection will have undesired effects. It is not obvious that employing mechanical decoupling at the point of attachment of the top cymbal-an essential feature of the VDEHC—would actually put the drummer in better control and result in a more realistic playing experience and performance, while at the same time improving the detection of foot position in an unimpeded manner. This feature virtually eliminates the unwanted interference artifacts present in other systems with a novel, simple design change. Due to its simplicity and relatively low cost, in light if its key enhancements in performance, control and aesthetics, the VDEHC approach would have been employed, had it been obvious.

The VDEHC design is novel. Until now, hi-hat controllers have employed a directly coupled clutch design. The novelty of the VDEHC lies in the fact that, as never before available, it uniquely variably decouples the strike force applied to the top cymbal from the foot pedal, while at the same time, maintaining a precise, direct connection between actual foot position and the controller's moveable sensor element. As a result, the VDHC captures a more realistic hi-hat performance and enhances the drummer's experience, without sacrifices in performance, feel or aesthetics, a combination of attributes not previously available with earlier designs.

In terms of its usefulness, the VDEHC combines all the benefits of a stand-mounted hi-hat with the precision offered by remote foot controllers. No longer do drummers have to sacrifice feel or aesthetics for performance and precision. Being stand-mounted, it offers a more realistic playing experience. This includes both ergonomics and haptic feedback from the cymbals to the foot, not possible with remote pedal controllers. Because the moveable sensor element remains directly, mechanically linked to the pull rod and ultimately to the drummer's foot, precise control and detection of position is achieved. In effect actual foot position directly correlates with sensed foot position; there is virtually no interference. In addition, being stand-mounted, it has the aesthetics features of traditional acoustic hi-hats. The VDEHC is superior to previously-available designs and is more useful to drummers in all respects—feel, control, precision, performance and aesthetics.

1. A variably decoupled hi-hat clutch assembly for use with an electronic hi-hat controller, comprising of:
a. a mounting mechanism configured to be firmly attached to a foot-activated hi-hat stand's pull rod;
b. a coupling assembly configured to support a top hi-hat cymbal allowing natural sway of said cymbal by virtue of said assembly;
c. a resilient suspension element comprising of a spring or other elastic material;
d. wherein the resilient suspension element and coupling assembly are configured to allow sufficient freedom of motion between the top hi-hat cymbal and the pull rod to minimize mechanical interference of the player's intended foot position when striking the top cymbal, thereby enabling enhanced control of the pull rod and foot pedal assembly and precise measurement of its position by a motion sensor.

2. The invention of claim 1, further comprising of:
a. a bottom hi-hat cymbal or base which is intended to come in contact with the top cymbal, said bottom cymbal being firmly mounted to a hi-hat stand so as not to wobble or move longitudinally with respect to said stand;
b. a motion sensor which includes a fixed element which is firmly attached to the hi-hat stand and a moveable element which is firmly attached to the hi-hat clutch assembly or pull rod, thereby measuring the upward and downward motion of the foot pedal.

3. The invention of claim 1, further comprising of a manual adjustment feature that allows for calibration of the sensor system by mechanically raising or lowering the fixed sensor element of said system by means of a manually actuated knob.
